(19) United States
(12) Patent Application Publication
(10) Pub. No.: US 2012/0054088 A1
(43) Pub. Date: Mar. 1, 2012

(54) APPARATUS AND METHOD FOR SHORT TERM LOANS

(76) Inventors: Shane Edrington, Scottsdale, AZ (US); Ross Fonner, Phoenix, AZ (US); Randy Humphrey, Scottsdale, AZ (US)

(21) Appl. No.: 12/868,699

(22) Filed: Aug. 25, 2010

(51) Int. Cl. G06Q 40/00

(52) U.S. Cl. 705/38

(57) ABSTRACT

The present invention comprises an apparatus and method for integrating a payday loan with a preconfigured repayment mechanism via contractual relationships between a lender and at least one of an employer or a payroll processing company. The most preferred embodiments of the present invention provide a mechanism for a worker to take a payroll “advance” against hours worked or hours to be worked, with the repayment of the payroll advance being automatically deducted from one or more subsequently issued paychecks by the payroll processing company or the employer. The most preferred embodiments of the present invention further comprise a series of software and/or hardware components that facilitate the automation of the payday loan process. The automation of the process makes the issuance of payday advances and the repayment of payday advances as streamlined and efficient as reasonably possible, thereby reducing the costs of participation for all parties involved.

### BACKGROUND OF THE INVENTION

1. Technical Field

This invention relates generally to banking and more specifically relates to short term financing lending operations such as “payday loans.”

2. Background Art

The borrowing and lending of money is a well-established practice in American life. Borrowers having well-established credit as a consequence of owning a business or a home normally are able to borrow money at relatively low interest rates. These borrowers present relatively little risk to a lender. Accordingly, lenders, such as banks, when dealing with such borrowers, are able, themselves, to borrow funds at a first interest rate and loan out the funds at a second interest rate that typically may be 1-3% higher than the first interest rate. Since the default rate on such loans is extremely low, the lender can depend upon a predictable return on his investment.

Borrowers who are not able to offer collateral such as a business, home, or other assets to a prospective lender, frequently resort to store-front lending institutions, which offer short-term loans at relatively high interest rates. These loans, sometimes referred to as “payday loans,” may be secured by a post-dated check offered by a borrower with the understanding that the post-dated check may be used to payoff the loan on a loan due date if the loan has not been paid off by that time. These loans result in relatively high risk to a lender, and so the interest rates charged for these loans are generally quite high.

Further, because of the significant potential for abuse by borrowers in such situations, many states frequently impose tight restrictions on such loans and the regulation of the payday loan industry is becoming increasingly onerous, making this type of short term high risk lending more difficult as time goes on. Additionally, given the difficulty associated with collecting on payday loans, many payday lenders have suffered significant losses and have simply gone out of business.

As another alternative for short term financing via payday loans, a borrower may also approach his or her employer, requesting a cash advance against a future paycheck. Since most employers are not in a business of making short-term, high-risk loans, such arrangements are rare and, when entered into, may lead to an unhealthy employer-employee relationship that may best be avoided. Accordingly, without some type of significant advance in the current state of the art for short term financing, those individuals without sufficient collateral to qualify for conventional lending will continue to be left with sub-optimal solutions.

### SUMMARY OF THE INVENTION

The preferred embodiments of the present invention comprise an apparatus and method for integrating a payday loan with a preconfigured repayment mechanism via contractual relationships between a lender and at least one of an employer or a payroll processing company. The most preferred embodiments of the present invention provide a mechanism for a worker to take a payroll “advance” against hours worked or hours to be worked, with the repayment of the payroll advance being automatically deducted from one or more subsequently issued paychecks by the payroll processing company or the employer. The most preferred embodiments of the present invention further comprise a series of software and/or hardware components that facilitate the automation of the payday loan process. The automation of the process makes the issuance of payday advances and the repayment of payday advances as streamlined and efficient as reasonably possible, thereby reducing the costs of participation for all parties involved.

### BRIEF DESCRIPTION OF THE DRAWINGS

Various aspects of implementations of a payday loan advance system and methods will hereinafter be described in conjunction with the appended drawings, where like designations denote like elements, and:

FIG. 1 is a schematic diagram illustrating the relationships and interactions of multiple parties in a conventional payday loan advance environment;

FIG. 2 is a block diagram illustrating the relationships and interactions of multiple parties in a payday loan advance environment in accordance with a preferred embodiment of the present invention;

FIG. 3 is a block diagram of one particular implementation of a payday loan advance apparatus and method in accordance with a preferred embodiment of the present invention;

FIG. 4 is a block diagram of a particular implementation of a computer system for implementing a payday loan advance apparatus and method in accordance with a preferred embodiment of the present invention; and

FIG. 5 is a flow chart of a methodology for conducting payday loan activities in accordance with a preferred embodiment of the present invention;

FIG. 6 is a flow chart of a methodology for conducting payday loan activities in accordance with a preferred embodiment of the present invention;

FIG. 7 a block diagram illustrating the relationships and interactions of multiple parties in a payday loan advance environment in accordance with an alternative preferred embodiment of the present invention; and

FIG. 8 is a block diagram of certain considerations to be evaluated when configuring the parameters for a payday loan advance made in accordance with a preferred embodiment of the present invention;

### DETAILED DESCRIPTION

This disclosure, its aspects and implementations, are not limited to the specific methods, devices, and systems disclosed herein. Many additional elements, procedures, and techniques known in the art consistent with the intended use of the methods and apparatus described will become apparent for use with various implementations of lending operations from this disclosure. Accordingly, for example, although particular methods or systems may be disclosed, the methods and systems of the present invention may be implemented in many forms known in the art for such systems and methods consistent with requirements of other lending operations.

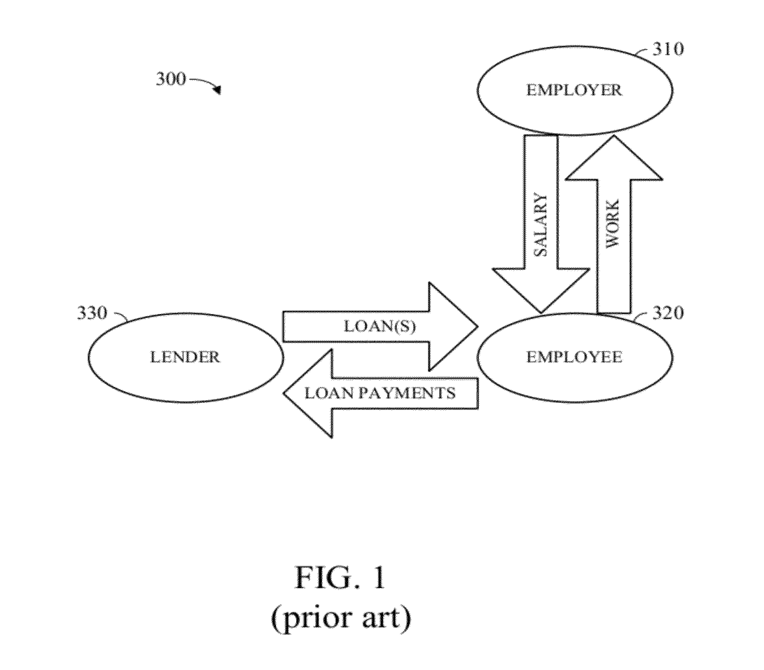

Referring now to FIG. 1, a typical method of processing payday loan advances in a conventional situation provides a convenient contrast to particular methods described herein. As shown in FIG. 1, an employee 320 provides work or services for and on behalf of an employer 310. In return, employer 310 provides a salary to employee 320. From time-to-time, employee 320 may require funds in excess of those that are received from employer 310. In that situation, employee 320 may take another job and establish a similar relationship with another employer. Alternatively, employee 320 may seek assistance from other sources, including a lender 330.

For purposes of this disclosure, lender 330 is a lender who participates in advance loans such as the previously described “payday” loans. Accordingly, employee 320 may get one or more loans from lender 330 and then, in accordance with the terms and conditions of the loans, employee 320 will make loan payments to lender 330 in order to pay the debt and retire the loans.

The specifics of the loan application and approval process are described in greater detail in the parent patent application for this application and are not repeated herein.

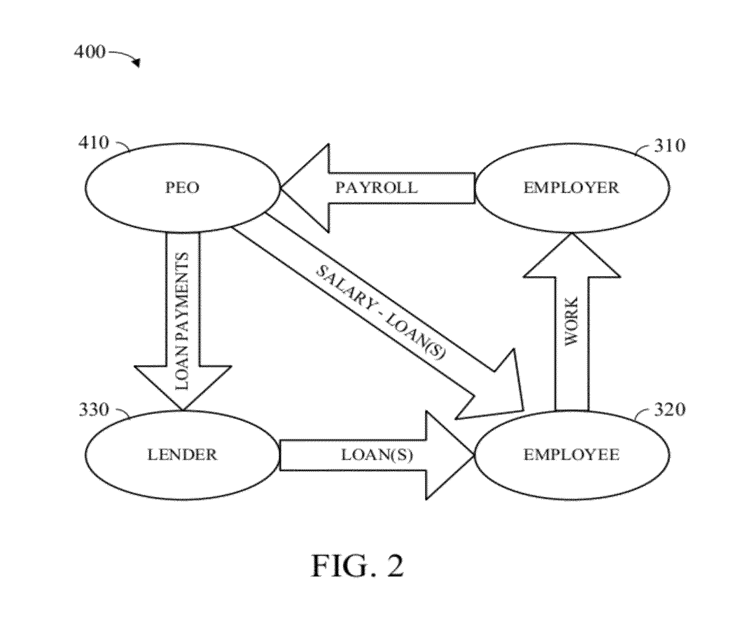

Referring now to FIG. 2, a method of processing payday loan advances in accordance with a preferred embodiment of the present invention provides a convenient contrast to the previously known methods of implementing payday loans. As shown in FIG. 2, a payroll processing company or professional employer organization (“PEO”) 410 has been added to the relationship and process in order to accomplish the objectives of the present invention. For purposes of this disclosure, PEO 410 is considered to be any organization, individual, or entity that generally provides for the outsourcing of payroll, workers' compensation, human resources and/or employee benefits administration. By offering payday advance loans via a pre-existing relationship with employer 310, the payday loan can be offered as an employee benefit by employer 310 and can significantly reduce the transaction costs associated with employee 320 obtaining a payday loan. Additionally, given the fact that the loan payments are made directly by PEO 410, the default rate may be significantly lower, thereby enticing more lenders to enter the market.

It should also be noted that in some cases, PEO 410 may actually become the lending entity or lender that offers the short-term loans to employee 320 of employer 310. Alternatively, the short-term loan program may be offered by PEO 410 directly to employees 320 working in concert with a lending institution, without the sponsorship of employer 310. Accordingly, it should be understood that the actual identity of the parties is not as important and the functions offered by the various parties and, in certain preferred embodiments of the present invention, a single entity (e.g., employer 310 or PEO 410) may act in all of the roles necessary to implement the methods described herein.

For the most preferred embodiments of the present invention, PEO 410 becomes an integral part of the process of issuing and satisfying one or more payday loans. For example, in the most preferred embodiment of the present invention, PEO 410 has a contractual relationship with employer 310 and, instead of employer 310 making salary payments to employee 320, PEO 410 will receive the funds for the payroll of employer 310 and disburse the salaries to the various employees of employer 310, including employee 320.

In order to provide payday loans, lender 330 will enter into a contractual relationship with PEO 410. The agreement will also typically include employer 310 as well. With the appropriate contracts in place, lender 330 may enter into a contract with employee 320 to provide employee 320 with a payday loan. However, instead of employee 320 making payments directly to lender 330, PEO 410 will monitor the loan between employee 320 and lender 330 and make loan payments to lender 330 for and on behalf of employee 320. In this fashion, PEO 410 divides the regular salary earmarked for employee 320 and sends a loan payment to lender 330 and the balance of the salary for employee 320 directly to employee 320. This process, where loan payments are made to lender 330 by PEO 410, provides lender 330 with greater assurances that the loan will be repaid and, accordingly, can serve to reduce the transaction costs for making payday loans.

For the most preferred embodiments of the present invention, the amount of the loan that employee 320 can receive will be based on a number of qualifying criteria. For example, the first criteria may be the number of hours worked by employee 320 in the previous 2-4 pay periods. This figure and amount of the loan requested can be evaluated to create an appropriate risk rating for employee 320. Additionally, the terms of the payday loan may also depend on not only the traditional measurements (e.g., credit score of employee 320), but may also include the absentee record of employee 320, including number of sick days and vacation days can be considered as part of the qualifying process to determine whether or not employee 320 can qualify for a loan and, if qualified, what type of terms (e.g., interest rate, payment schedule, etc.) that employee 320 may qualify for. In yet another preferred embodiment of the present invention, the hours to be worked in upcoming pay periods may also be considered when determining the loan eligibility of a prospective borrower and terms for a payday loan to be made to employee 320 by lender 330.

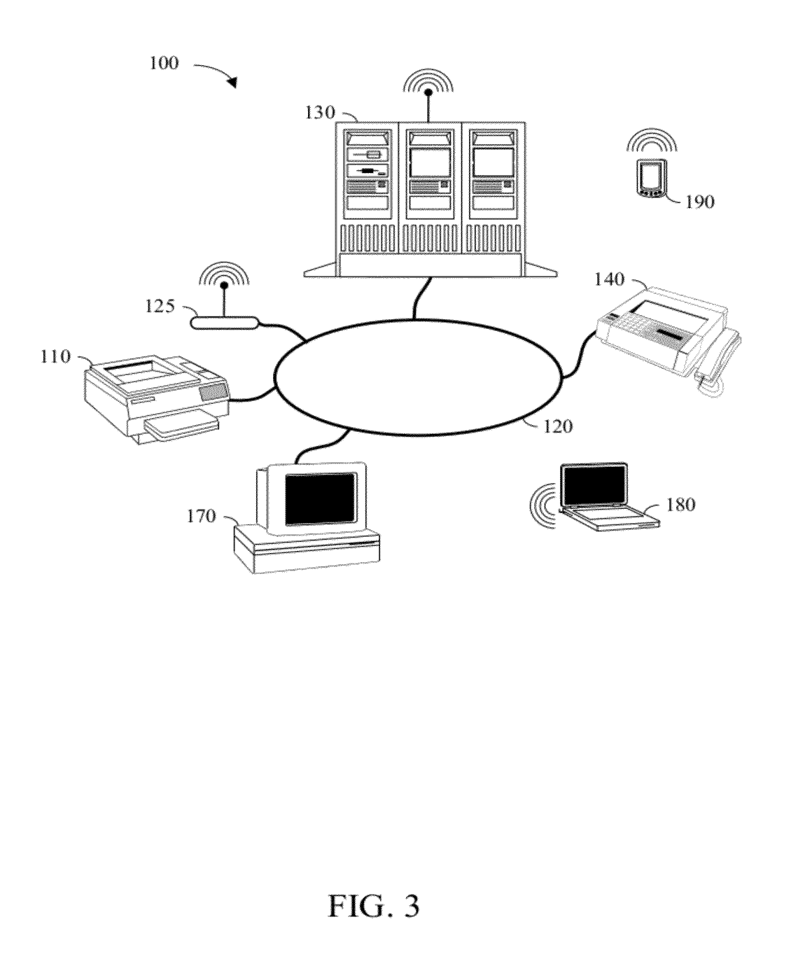

Referring now to FIG. 3, a computer-based payday advance loan system 100 in accordance with a preferred embodiment of the present invention comprises: at least one wireless communication device 125; a data server 130; a desktop computer 170; a laptop computer 180, and a personal digital assistant (PDA) 190; all connected or coupled via a network 120. Additionally, an optional printer 110, and an optional fax machine 140 are shown. Those skilled in the art will recognize that each of the components or elements of FIG. 3 are merely illustrative in nature and represent a single instance or preferred embodiment of the present invention and that many variations are possible. For example, a netbook computer could take the place of both desktop computer 170 and laptop computer 180 for certain embodiments. Additionally, certain components may be eliminated for certain preferred embodiments of the present invention. Accordingly, no limitation as the specific hardware components is intended or defined by the specificity of the system illustrated in FIG. 3.

Taken together, the components of computer-based payday advance loan system 100 provide a way for a disparate user base, including program administrators, managers, and clients, to access one or more components or subsystems of computer-based payday advance loan system 100 as described herein in conjunction with the various preferred embodiments of the present invention. While the present invention will be described in detail by using various examples of a unique process for initiating and servicing a payday advance loan, those skilled in the art will recognize that the methods and techniques described herein have broad applicability to other environments and applications where quick and efficient loan origination and processing procedures with more stable financial returns are desirable.

Network 120 is any suitable computer communication link or communication mechanism, including a hardwired connection, an internal or external bus, a connection for telephone access via a modem, standard co-axial cable lines, high-speed T1 line, radio, infrared or other wireless communication methodologies (i.e. “Bluetooth,” infrared (IR), etc.), private or proprietary local area networks (LANs) and wide area networks (WANs), as well as standard computer network communications over the Internet or an internal network (e.g. “intranet”) via a wired or wireless connection, or any other suitable connection between computers and computer components known to those skilled in the art, whether currently known or developed in the future. It should be noted that portions of network 120 may suitably include a dial-up phone connection, broadcast cable transmission line, Digital Subscriber Line (DSL), ISDN line, or similar public utility-like access link.

In the most preferred embodiments of the present invention, at least a portion of network 120 comprises a standard Internet connection between the various components of computer-based payday advance loan system 100. Network 120 provides for communication between the various components of computer-based payday advance loan system 100 and allows for relevant information to be transmitted from device to device. In this fashion, a user of computer-based payday advance loan system 100 can quickly and easily gain access to the relevant data and information utilized to search, retrieve, and display information from one or more databases as described in conjunction with the preferred embodiments of the present invention.

Wireless communication device 125 is communicatively coupled to network 120 and is representative of any wireless communication mechanism that may be used to provide for wireless communication between network 120 and the various devices associated with network 120, including desktop computer 170, laptop computer 180 and PDA 190. Wireless communication device 125 may comprise any type of wireless bridge, wireless router, or similar type of device.

Regardless of the specific components, physical nature, and topology, network 120 serves to logically and communicatively link the physical components of computer-based payday advance loan system 100 together, regardless of their physical proximity, thereby enabling communication between the components. This is especially important because in many preferred embodiments of the present invention, data server 130, desktop computer 170, and laptop computer 180 may be geographically remote and/or physically isolated from each other.

Data server 130 represents a relatively powerful computer system that is made available to desktop computer 170, laptop computer 180, and/or PDA 190 via network 120. Various hardware components (not shown this FIG.) such as external monitors, keyboards, mice, tablets, hard disk drives, recordable CD-ROM/DVD drives, jukeboxes, fax servers, magnetic tapes, and other devices known to those skilled in the art may be used in conjunction with data server 130. Data server 130 may also provide various additional software components (not shown this FIG.) such as database servers, web servers, firewalls, security software, and the like. The use of these various hardware and software components is well known to those skilled in the art.

Given the relative advances in the state-of-the-art computer systems available today, it is anticipated that functions of data server 130 may be provided by many standard, readily available data servers. This may also include the deployment of multiple inter-connected and redundant data servers 130 to enhance the availability and reliability of the functions provided by data server 130. Depending on the desired size and relative power required for data server 130, storage area network (SAN) technology may also be deployed in certain preferred embodiments of the present invention. Additionally, various biometric and identification verification devices for identifying users and controlling access as well as creating and verifying digital signatures (i.e., electronic signature processing) may also be included.

Desktop computer 170 may be any type of computer system known to those skilled in the art that is capable of being configured for use with computer-based payday advance loan system 100 as described herein. This includes various levels of desktop computers, tablet computers, pen-based computers and the like. Additionally, handheld and palmtop devices are also specifically included within the description of devices that may be deployed as a computer system 170. It should be noted that no specific operating system or hardware platform is excluded and it is anticipated that many different hardware and software platforms may be configured to create computer system 170. As previously explained in conjunction with data server 130, various hardware components and software components (not shown this FIG.) known to those skilled in the art may be used in conjunction with computer system 170. It should be noted that in the most preferred embodiments of the present invention, desktop computer 170 is linked (via wired or wireless connection) to its own LAN or WAN and has access to its own data server (not shown this FIG.).

Similarly, laptop computer 180 may be any type of relatively lightweight portable computer system known to those skilled in the art that is capable of being configured for use with computer-based payday advance loan system 100 as described herein. This includes tablet computers, pen-based computers and the like. Additionally, handheld and palmtop devices are also specifically included within the description of devices that may be deployed as a laptop computer 180. It should be noted that no specific operating system or hardware platform is excluded and it is anticipated that many different hardware and software platforms may be configured to create laptop computer 180. As previously explained in conjunction with data server 130, various hardware and software components (not shown this FIG.) known to those skilled in the art may be used in conjunction with laptop computer 180. It should also be noted that in the most preferred embodiments of the present invention, laptop computer 180 is linked to its own LAN or WAN and has access to its own data server (not shown this FIG.).

In general, the communication between devices associated with data server 130 will be requests for entering data into or retrieving data from one or more databases located on data server 130. The users of desktop computer 170 and/or laptop computer 180 may be program administrators, managers, and/or prospective clients who are seeking to make determinations regarding loan program selection, loan eligibility and related activities. Additionally, various related service providers such as government agencies, banks, benefits administrators, and their employers and agents may also have access to one or more databases located on data server 130 via desktop computer 170 and/or laptop computer 180. A typical transaction may be represented by a request for a payday loan by a prospective borrower. In response to the request for a loan application, various types of information may be transmitted to and from the prospective borrower in order to create and access the prospective borrower's data file. This data may be sent from desktop computer 170 and/or laptop computer 180 to data server 130 creating interaction with computer-based payday advance loan system 100 where loan eligibility and processing activities can take place.

Upon receipt of a valid request, data server 130 processes the request to access one or more databases containing the relevant information and takes the specific action requested by desktop computer 170 and/or laptop computer 180, typically by retrieving and returning the requested data or analysis to desktop computer 170 and/or laptop computer 180. The request may be directed towards locating a specific item in a database, comparing one or more items in the database, obtaining additional information from a database about one or more prospective borrowers, determining and calculating loan eligibility and payment schedules, or other similar requests.

It should be noted that while FIG. 3 shows only a single desktop computer 170 and a single laptop computer 180, it is anticipated that the most preferred embodiments of the present invention will comprise hundreds and even thousands of computer systems 170 and laptop computers 180. Each of these computers 170 and 180 will be configured to access data server 130 in an appropriately secure way so as to accomplish the specific objectives of the user of the desktop computer 170 or laptop computer 180. For example, the service provider that controls the databases stored on data server 130 may utilize desktop computer 170 or laptop computer 180 to access data server 130 and create or modify a given database. A lender, located in a remote location, may use desktop computer 170 or laptop computer 180 to access data server 130 to retrieve information about prospective borrowers or applicants for one or more loan programs using data that are stored in a database on data server 130, etc.

In the most preferred embodiments of the present invention, multiple desktop computers 170 and multiple laptop computers 180 will all be configured to communicate simultaneously with data server 130 and with each other via network 120. In addition, the most preferred embodiments of the present invention include a Software as a Service (“SaaS”) or Application Service Provider (ASP) environment where data server 130 is operated as a clearinghouse in a hosted application operation. In this fashion, multiple desktop computers 170 and laptop computers 180 will have access to data server 130 and the databases stored thereon via a global computer network such as the Internet. Data server 130 is further described below in conjunction with FIG. 2 below.

Optional printer 110 and an optional fax machine 140 are standard peripheral devices that may be used for transmitting or outputting paper-based documents, notes, transaction details, reports, etc. in conjunction with the various requests and transactions processed by computer-based payday advance loan system 100. Optional printer 110 and an optional fax machine 140 may be directly connected to network 120 or indirectly connected to network 120 via any or all of desktop computers 170, laptop computers 180, and/or data server 130. Finally, it should be noted that optional printer 110 and optional fax machine 140 are merely representative of the many types of peripherals that may be utilized in conjunction with computer-based payday advance loan system 100. It is anticipated that other similar peripheral devices will be deployed in the various preferred embodiment of the present invention and no such device is excluded by its omission in FIG. 3. These devices can be used to transmit, transfer, and otherwise provide various forms of eye-legible output and results from computer-based payday advance loan system 100. In addition, audible-output, tactile output and other forms of output may be implemented in certain preferred embodiments of the present invention to provide additional interactive elements that may be recognized by human operators of computer-based payday advance loan system 100.

Those skilled in the art will recognize that FIG. 3 depicts a fairly standard “client/server” type communication configuration where data server 130 is considered to be a server and computers 170 and 180 are considered to be clients of data server 130. Additionally, those skilled in the art will recognize that the functionality of data server 130 may be deployed on either of computers systems 170 and 180 in a more traditional “stand-alone” environment. In either case, certain variations of the most preferred embodiments of the methods of the present invention are designed to minimize the amount of data that must be transferred from one or more databases to the user of computer-based payday advance loan system 100.

Personal digital assistant (PDA) 190 is representative of a class of devices that may be, in some embodiments of the present invention, somewhat less full-featured and less powerful than computers 170 and 180. This includes, for example, netbooks, Windows mobile OS devices, Palm OS devices, Pocket PC devices, and various types of “smart phones” (e.g., iPhone, Blackberry, Pre, etc.) for example. Those skilled in the art will recognize these various devices and others that are suitable for deployment as PDA 190. While possibly less powerful than computers 170 and 180, PDA 190 is also configured to communicate with data server 130 via network 120 to send and retrieve loan origination, processing and payment information to and from data server 130. Given the standard functionality for devices that may be deployed as PDA 190, this communication will typically be a wireless telephone network or a wireless Internet connection (e.g. “wi-fi” or “wi-max”) or a Bluetooth connection. One example of the use for PDA 190 in the context of computer-based payday advance loan system 100 would be borrower checking a loan balance or making arrangements to transfer funds with the resulting transactions being collected and stored in a database on data server 130 for processing purposes or for later access and/or review. Additionally, those skilled in the art will recognize that any borrower or lender transaction described herein may be performed on computers 170 and 180, as well as PDA 190, at least in certain preferred embodiments of the present invention.

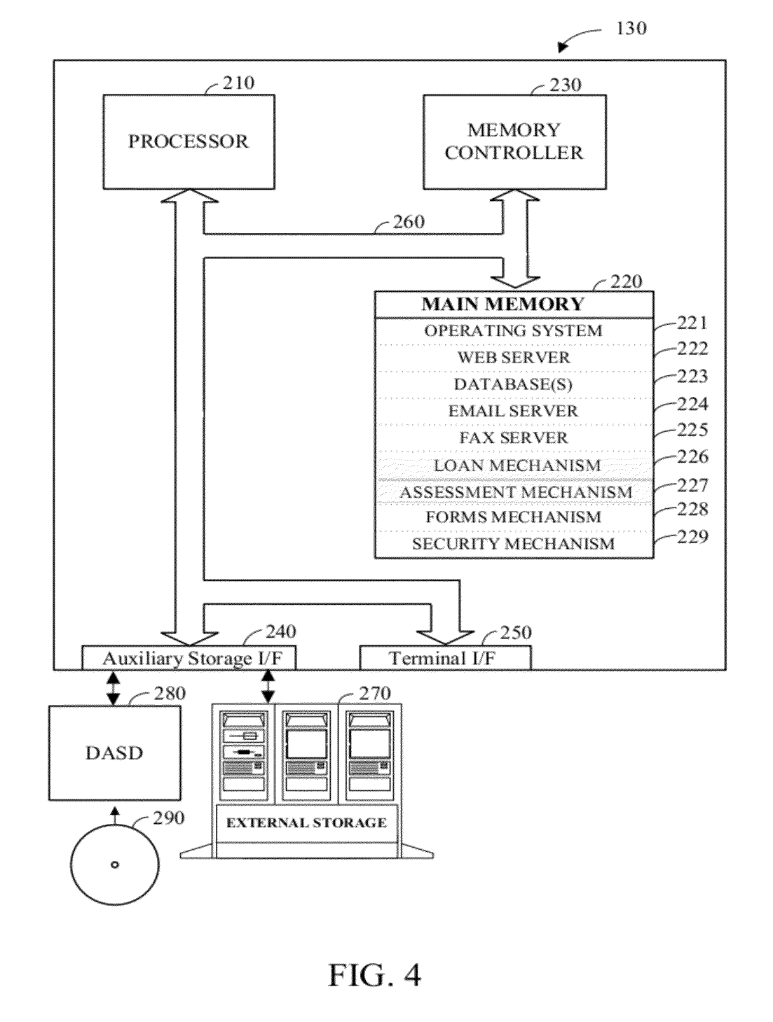

Referring now to FIG. 4, a block diagram of data server 130 from FIG. 3 is depicted. In accordance with one or more preferred embodiments of the present invention, data server 130 represents one of many commercially available computer systems such as, for example only, a Linux-based computer system, an IBM compatible computer system, or a Macintosh computer system. However, those skilled in the art will appreciate that the methods and apparatus of the present invention apply equally to any computer system, regardless of the specific operating system and regardless of whether the computer system is a traditional “mainframe” computer, a complicated multi-user computing apparatus operating via a network, or a single user device such as a personal computer or workstation.

Data server 130 suitably comprises at least one Central Processing Unit (CPU) or processor 210, a main memory 220, a memory controller 230, an auxiliary storage interface 240, and a terminal interface 250, all of which are interconnected via a system bus 260. Terminal interface 250 may also comprise a network interface for interfacing with network 120 of FIG. 3. Note that various modifications, additions, or deletions may be made to data server 130 illustrated in FIG. 4 within the scope of the present invention such as the addition of cache memory or other peripheral devices. FIG. 4 is not intended to be exhaustive, but is presented to simply illustrate some of the more salient features of data server 130.

Processor 210 performs computation and control functions of data server 130, and most preferably comprises a suitable central processing unit (CPU). Processor 210 may comprise a single integrated circuit, such as a microprocessor, or may comprise any suitable number of integrated circuit devices and/or circuit boards working in cooperation to accomplish the functions of a processor or CPU. Processor 210 suitably executes one or more software programs contained within main memory 220.

Auxiliary storage interface 240 allows data server 130 to store and retrieve information from auxiliary storage devices, such as external storage mechanism 270, magnetic disk drives (e.g., hard disks or floppy diskettes) or optical storage devices (e.g., CD-ROM). One suitable storage device is a direct access storage device (DASD) 280. As shown in FIG. 4, DASD 280 may be a DVD or CD-ROM drive that may read programs and data from a DVD or CD disk 290.

It is important to note that while certain preferred embodiments of the present invention have been (and will continue to be) described in the context of a fully functional computer system with certain application software, those skilled in the art will appreciate that the various software mechanisms of the illustrated embodiments of the present invention are capable of being distributed in conjunction with tangible signal bearing media as one or more program products in a variety of forms, and that the various preferred embodiments of the present invention applies equally regardless of the particular type or location of signal bearing media used to actually carry out the distribution. Examples of signal bearing media include: recordable type media such as DVD and CD ROMS disks (e.g., disk 290), and transmission type media such as digital and analog communication links, including wireless communication links. Additionally, computer-readable storage devices including magnetic, optical, flash memory cards and sticks, and magneto-optical devices for storing computer-readable software code, data, and/or other signals may be used as well.

Various preferred embodiments of the program product may be configured to: create and modify multiple databases; track, update and store loan eligibility and processing information for a plurality of borrowers and prospective borrowers, employers and companies, benefits coordinators, etc.; configure and implement various search and retrieve functions for a multitude of loan program participation and loan eligibility search requests and determinations made by users of the system; track and store information about various loan programs and loan eligibility requirements; update and transmit search results to one or more users; and provide one or more user interfaces for accomplishing all of these functions. In this fashion, the appropriate entities (i.e., administrators, employers, borrowers, etc.) can utilize the program product to initiate and complete a wide variety of database-related applications related to payday loan processing. Similarly, a program product in accordance with one or more preferred embodiments of the present invention can also be configured to perform substantially all of the steps depicted and described in conjunction with the figures below for implementing an computer-based payday advance loan system.

Memory controller 230, through use of an auxiliary processor (not shown) separate from processor 210, is responsible for moving requested information from main memory 220 and/or through auxiliary storage interface 240 to processor 210. While for the purposes of explanation, memory controller 230 is shown as a separate entity; those skilled in the art understand that, in practice, portions of the function provided by memory controller 230 may actually reside in the circuitry associated with processor 210, main memory 220, and/or auxiliary storage interface 240.

Terminal interface 250 allows users, managers, system administrators, and/or computer programmers to communicate with data server 130, normally through separate workstations or through stand-alone computer systems such as computer systems 170 and computer systems 180 of FIG. 3. Although data server 130 depicted in FIG. 4 contains only a single main processor 210 and a single system bus 260, it should be understood that the present invention applies equally to computer systems having multiple processors and multiple system buses. Similarly, although the system bus 260 of the preferred embodiment is a typical hardwired, multi-drop bus, any connection means that supports bi-directional communication in a computer-related environment could be used.

Main memory 220 suitably contains an operating system 221, a web server 222, one or more databases 223, an email server 224, a fax server 225, a loan mechanism 226, an assessment mechanism 227, a forms mechanism 228, and a security mechanism 229. Loan mechanism 226, assessment mechanism 227, and forms mechanism 228 rules also comprise a user interface and a rules engine with workflow model to assist with the overall flow and processing of loan application and servicing operations, including data storage and retrieval. The term “memory” as used herein refers to any storage location in the virtual memory space of data server 130.

It should be understood that main memory 220 might not necessarily contain all parts of all components shown. For example, portions of operating system 221 may be loaded into an instruction cache (not shown) for processor 210 to execute, while other files may well be stored on magnetic or optical disk storage devices (not shown). In addition, although database 223 is shown to reside in the same memory location as operating system 221, it is to be understood that main memory 220 may consist of multiple disparate memory locations. It should also be noted that any and all of the individual components shown in main memory 220 might be combined in various forms and distributed as a stand-alone program product. Finally, it should be noted that additional software components, not shown in this figure, might also be included.

For example, most preferred embodiments of the present invention will include a security and/or encryption mechanism 229 for verifying access to the data and information contained in and transmitted by data server 130. Security mechanism 229 may be incorporated into operating system 221 and/or web server 222. Additionally, security mechanism 229 may also provide encryption capabilities for other components of computer-based payday advance loan system 100 of FIG. 3, thereby enhancing the robustness of computer-based payday advance loan system 100. Security mechanism 229 is most preferably configured to protect the integrity and security of the information stored on data server 130 and transmitted via network 120 of FIG. 3. Given the present levels of concern for the protection of personally identifiable information (PII) by directives such as the Graham-Leach Bliley Act (GLBA) and the recently implemented “Red Flag” requirements, the function of security mechanism 229 is important for compliance issues and to ensure that all PII is adequately protected from inadvertent disclosure and unauthorized access.

Once again, depending on the type and quantity of information stored in database 223 and accessed by assessment mechanism 227, security mechanism 229 may provide different levels of security and/or encryption for different computer systems 170 and 180 of FIG. 3. Additionally, the level and type of security measures applied by security mechanism 229 may be determined by the identity of the end-user and/or the nature of a given request and/or response. In some preferred embodiments of the present invention, security mechanism 229 may be contained in or implemented in conjunction with certain hardware components (not shown this FIG.) such as hardware-based firewalls, switches, dongles, and the like.

Operating system 221 includes the software that is used to operate and control data server 130. In general, processor 210 executes operating system 221. Operating system 221 may be a single program or, alternatively, a collection of multiple programs that act in concert to perform the functions of an operating system. Any operating system now known to those skilled in the art or later developed may be considered for inclusion with the various preferred embodiments of the present invention.

Web server 222 may be any web server application currently known or later developed for communicating with web clients over a network such as the Internet. Examples of suitable web servers 222 include Apache web servers, Linux web servers, and the like. Additionally, other vendors have developed or will develop web servers that will be suitable for use with the various preferred embodiments of the present invention. Web server 222 is most preferably configured to interact with the other components shown in FIG. 2 to provide access to the functions of computer-based payday advance loan system 100 of FIG. 1.

Finally, while depicted as a single element, in certain preferred embodiments of the present invention web server 222 may be implemented as a cluster of multiple web servers, with separate and possibly redundant hardware and software systems. This configuration provides additional robustness for system uptime and reliability purposes. Regardless of the specific form of implementation, Web server 222 provides access, including a user interface, to allow individuals and entities to interact with loan mechanism 226 including via network 120 of FIG. 3.

Database 223 is representative of any suitable database known to those skilled in the art. In the most preferred embodiments of the present invention, database 223 is a Structured Query Language (SQL) compatible database file capable of storing information relative to various items that may be of interest to the users of computer-based payday advance loan system 100 of FIG. 1. In the most preferred embodiments of the present invention, database 223 will comprise a collection of information about employers, lenders, POE organizations, borrowers, potential borrowers and their attributes and specific situation/circumstances as well as providing for the tracking and management of multiple programs, programs requirements, procedures and protocols that may be used to provide various services to the users of computer-based payday advance loan system 100 of FIG. 1.

Those skilled in the art will recognize that other types of information for other types of data that may be used in other applications (e.g., historical, informational, technical, etc.) may be stored and retrieved as well. While database 223 is shown to be residing in main memory 220, it should be noted that database 223 may also be physically stored in a location other than main memory 220. For example, database 223 may be stored on external storage device 270 or DASD 280 and coupled to data server 130 via auxiliary storage I/F 240. Additionally, while shown as a single database 223, those skilled in the art will recognize the database 223 may actually comprise a series of related databases, logically linked together. Depending on the specific application and design parameters, database 223 may take many different forms when implemented.

While not required, the most preferred embodiments of data server 130 of FIG. 3 will typically include an email server 224. E-mail server 224 is any email server application capable of being configured and used to send and receive various status messages and updates to data server 130 and between computers 170, 180, and/or PDA 190 of FIG. 3 via email, as may be necessary to enhance the overall process of completing various indexing, search-and-retrieve and/or loan eligibility determination and servicing transactions described herein. This includes the generation of automated email messages relating to the tracking and management of various loan programs and features (e.g., eligibility requirements, application forms, amortization schedules, payment due dates, etc.) as well as informational messages related to borrowers and prospective borrowers regarding their loans or loan applications and the status of computer-based payday advance loan system 100 of FIG. 3. Automated e-mail messages are also generated to provide notifications regarding the status of user accounts as well as other information for related to the programs and borrowers or prospective borrowers in accordance with the preferred exemplary embodiments of the present invention.

Optional fax server 225 is any fax server known to those skilled in the art and is configured to receive inbound fax messages and to transmit outbound fax messages. Fax server 225 may format and transmit any data processed by computer-based payday advance loan system 100 of FIG. 3 and make it available for use by any other component of computer-based payday advance loan system 100 of FIG. 3, including particularly fax machine 140 of FIG. 3. Additionally, fax server 225 may process the data received and send it directly to web server 222 and make the incoming data available for further processing by computer-based payday advance loan system 100, including loan mechanism 226, assessment mechanism 227, and forms mechanism 228.

Loan mechanism 226 is a software mechanism that performs the critical functions of computer-based payday advance loan system 100 of FIG. 1. This includes processing data for determining the potential eligibility of a prospective borrower for participation in one or more payday loan programs. The most preferred embodiments of the present invention preferably comprises one or more user customizable web-based templates that can be utilized to create one or more user interfaces for accessing loan mechanism 226. In this fashion, loan mechanism 226 may be readily adapted for multiple programs and multiple borrowers or prospective borrowers and the companies or entities that are providing the loan origination and servicing functions.

Assessment mechanism 227 is a software mechanism that helps to quickly and more efficiently gather the data points necessary for a candidate to participate in one or more programs. The most preferred embodiments of the present invention preferably comprises one or more user customizable web-based templates that can be utilized to create one or more user interfaces for accessing assessment mechanism 227. In this fashion, assessment mechanism 227 may be readily adapted for multiple programs and multiple candidates. Assessment mechanism 227 may also be configured to evaluate prospective borrowers and calculate risk profiles for prospective borrowers that will provide the necessary data for determining loan eligibility, loan limits, and interest rates on a case-by-case basis.

Forms mechanism 228 is a software mechanism that helps in formatting and creating the various forms necessary to complete the loan application process for a prospective borrower in conjunction with one or more loan programs. The most preferred embodiments of the present invention preferably comprises one or more user customizable web-based templates that can be utilized to create one or more user interfaces for accessing form mechanism 228. In this fashion, forms mechanism 228 may be readily adapted for multiple programs and multiple candidates. In addition, forms mechanism 228 is configured for deployment in a “rendering process” that takes the information gathered from the prospective borrower during the application process and embeds it onto a paper-based form or some type of electronic format for transmission to a destination via network 120.

Additionally, in the most preferred embodiments of the presenting invention, forms mechanism 228 may be configured to perform a form filtering function. The form filtering mechanism is configured to review the actual loan programs that a given borrower is eligible for, after completion of the data-gathering process during the initial application process. With the eligible programs being identified, the specific forms required for completing the forms necessary for participating in a given loan program can also be identified. The form filtering mechanism is also configured to identify the specific data elements necessary for rendering the forms required for approving the candidate and completing the forms necessary for the selected loan or loans. Then, the form filtering mechanism may generate additional questions to be posed to the candidate to solicit any required information that has not already been collected during the original application process.

Since there are many types of possible destinations and sources, there is no particular limitation on the output of forms mechanism 228. Those skilled in the art will recognize that word processing documents, PDF documents, database entries and other forms of data presentation and storage processes, whether electronic or paper-based, are all encompassed with the rendering process performed by forms mechanism 228. Since it is a relatively universal type of document for most operating systems, examples using a PDF document will be presented as one preferred embodiment for the output of the rendering process from forms mechanism 228. If a “wet” signature is necessary, an output device such as printer 110 of FIG. 1 may be utilized.

In this fashion, the users of computer-based payday advance loan system 100 of FIG. 3 can more effectively identify, qualify, and enroll prospective borrowers into one or more loan programs. The procedures set forth below will also allow computer-based payday advance loan system 100 of FIG. 3 to automatically generate email and or fax messages to be routed to the appropriate managers, user and operators of computer-based payday advance loan system 100 of FIG. 3, thereby increasing efficiency and reducing the time necessary to complete the overall qualification and loan initiation for prospective borrowers into various loan programs.

In the most preferred embodiments of the present invention, the various components of computer-based payday advance loan system 100 of FIG. 3 are able to communicate using multiple communications protocols, including “SOAP,” eXtended Markup Language (XML), and others. Those skilled in the art will recognize that the communication protocols used herein may be readily adapted and configured to allow for the rapid and efficient transmission and receipt of data by and between the various components of computer-based payday advance loan system 100 of FIG. 3. This would also include the ability to customize the input and output of computer-based payday advance loan system 100 of FIG. 3 for integration with other systems. The use of XML and similar electronic communication protocols in general is well known to those skilled in the art.

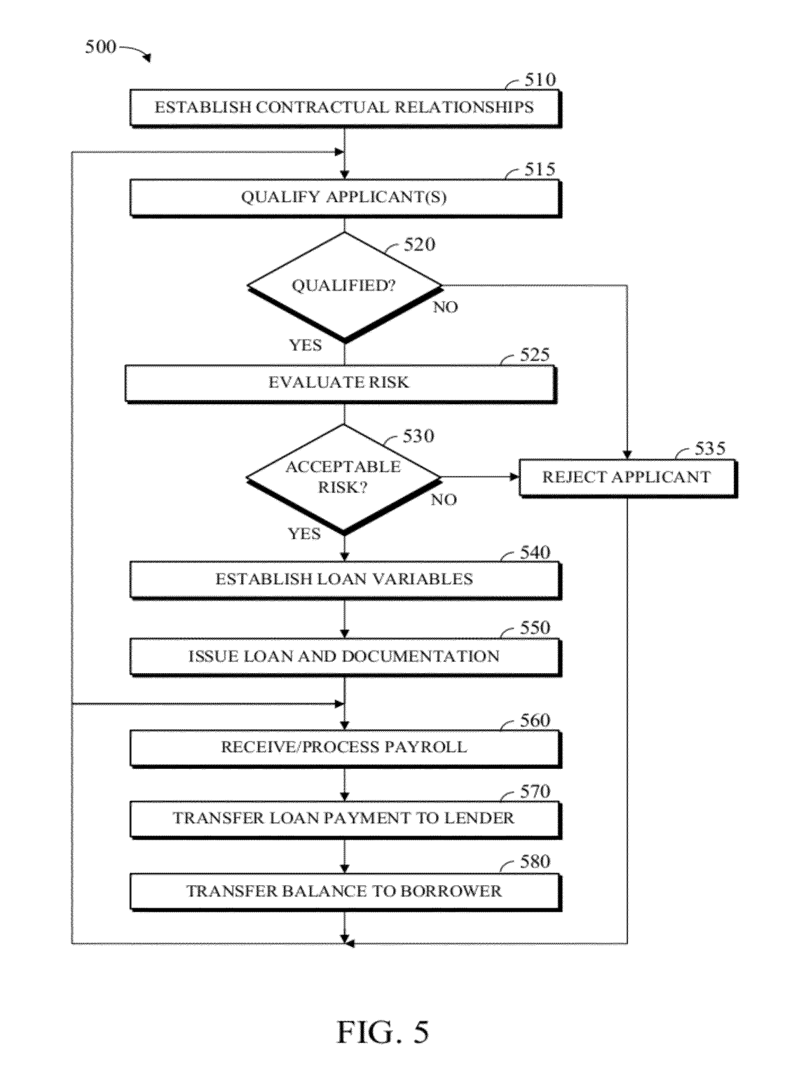

Referring now to FIG. 5, a method 500 for initiating and servicing a loan in accordance with a preferred embodiment of the present invention is depicted. As shown in FIG. 5, the decision to offer payday loans and the relationship of the parties that will participate in the payday loan process is typically established and set forth in one or more contracts (step 505). It should be noted that there will most likely be existing contracts in place between all of the entities shown in FIG. 2, however, given the unique nature of the present invention, the existing contracts will need to be modified to accommodate the payday loan origination and processing methodologies set forth herein.

Next, the process of qualifying applicants or prospective borrowers may take place (step 510). This step may be quite simple or relatively complex, depending on the specific application. For example, before a prospective borrower can be offered a loan, it may be necessary to verify that they are employed with a company or entity that has the appropriate contractual relationships established for participation in the payday loan program. Additionally, based on the lending laws in various states, additional criteria may come into play (e.g., age restrictions, etc.). If a prospective borrower is not qualified, they will be rejected (step 520=NO).

After qualifying a prospective borrower, (step 520=YES) it will be necessary to evaluate the risk associated with a given prospective borrower (step 525) so that appropriate loan variables may be established for the payday loan. It should be noted that just because a prospective borrower is technically “qualified” in step 520 (e.g., they are an employee of an entity that participates in the payday loan process) that does not mean that they will be offered a payday loan. The risk associated with a prospective borrower may be quantified in a number of ways. In addition to the risk factors typically associated with existing loan programs (e.g., credit score, home ownership, etc.) the methods of the present invention contemplate additional criteria that will be used for risk quantification purposes.

For example, since the payday loan will eventually be paid back to the lender from the employee's future earnings, and distributed to the lender by the PEO, a number of job-related factors that are not generally considered in a loan application will become relatively important. These job-related factors could be items such as the amount of the payday loan requested as a percentage of the prospective borrower's annual income, the frequency of payroll checks being issued by the employer, the number and timing of payroll checks for a given loan period, the employee's absenteeism history, the average number of sick days taken by the employee in a given pay period, frequency and timing of promotions for the employee, etc. By using all of these factors, it will be possible to quantify the risk for making a loan for given applicant. If the risk is deemed too great, the applicant will be rejected (step 530=NO). Each lender can establish their own criteria and the actual risk factor may vary from lender to lender.

If the risk for a prospective borrower is deemed acceptable (step 530=YES), the specific loan variables for that loan transaction may be set (step 540). Once again, using the risk factors previously identified, the interest rate, term of the loan, timing and amount of payments, etc. can all be used to set the loan parameters. Additionally, in at least one preferred embodiment of the present invention, loan limits may be prospectively established by calculating a percentage of future incomer earnings attributable to the borrower (e.g., no outstanding single loan may exceed XX % of the borrower's projected future earnings and/or no cumulative outstanding loan balance for a given borrower may exceed XX % of the borrower's projected future earnings, etc.).

Using the established loan parameters, the necessary loan documentation can be prepared, processed, and issued (step (550). Once the loan has been established, the PEO will receive and process the payroll from the employer (step 560). However, instead of following the conventional process of issuing the employee a paycheck, the PEO will first determine if the employee has an outstanding loan and, if so, the PEO will deduct the appropriate loan payment from the employee's paycheck and transmit the payment to the lender (step 570). Once all payments have been issued, the balance of the paycheck will be issued to the employee (step 580).

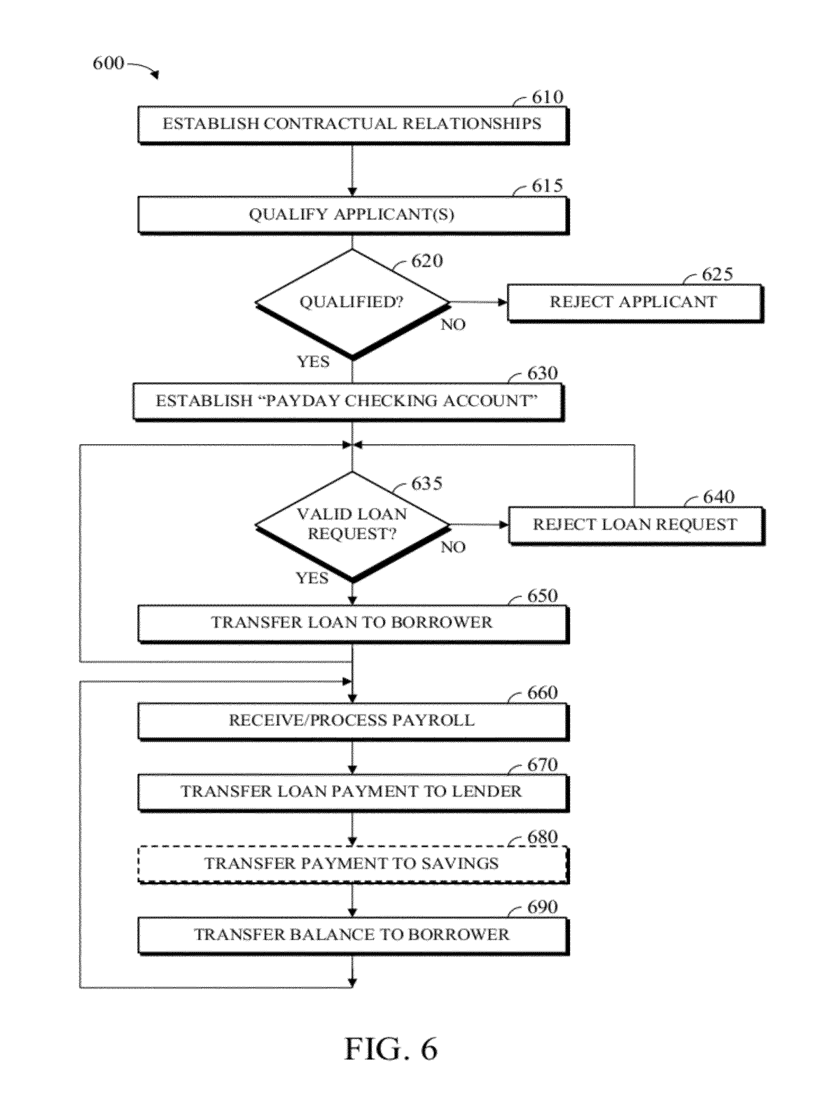

Referring now to FIG. 6, a method 600 of obtaining a short-term payroll loan in accordance with an alternative preferred embodiment of the present invention is depicted. As shown in FIG. 6, as with other preferred embodiments of the present invention, various contractual relationships should be established prior to offering and making payroll loans (step 610). In this particular instance, in addition to the other relationships described in conjunction with method 500 of FIG. 5, a more traditional lending institution, such as a bank that is capable of establishing and maintaining checking accounts, is typically included in method 600 of FIG. 6.

As with previous embodiments of the present invention, an applicant will still go through a screening process (step 615) to ensure that they and their employer are qualified and approved to participate in the payroll loan program. If the applicant and/or the applicant's employer are not qualified to participate in the program (step 620=“NO”), the applicant will be rejected (step 625).

However, if the applicant and associated employer are qualified to participate in the payroll loan program (step 620=“YES”), then the banking institution will establish a special checking account (step 630) to be used for the purpose of making payroll loans available to the applicant. In the most preferred embodiments of the present invention, this checking account will be a “sole purpose” checking account with the only funds going into and out of the account being directly related to the payroll loan.

Additionally, in the most preferred embodiments of the present invention, once the applicant is approved to receive loans, the maximum loan amount to be borrowed at any given time is advanced to the special purpose checking account and, typically, an administrative fee is also added to the balance. This is, essentially, a debit to the special purpose checking account that functions as a loan to the applicant that can be tapped into in the form of a loan whenever requested by the borrower.

For example, once the special purpose checking account has been established, the applicant can request an advance payroll loan through the user interface associated with computer-based payday advance loan system 100 of FIG. 3. If the applicant's request for a loan is not valid for any reason (e.g., already at maximum approved loan capacity, too high of a risk, poor repayment history, etc.) then the loan request will be rejected (step 640). If, however, the loan request is valid and approved (step 635=“YES”), then the amount of money requested, up to the approved limit, will be transferred to the borrower (step 650) and this will be treated as a draw against a line of credit. The transfer is typically accomplished by transferring the approved loan amount to the borrower's regular checking account (e.g., a previously established checking account owned or controlled by the borrower) or by some other traditional funds transfer mechanism (e.g., issuing the borrower a check, a debit card pre-loaded with the loan amount, etc.). However, in any case, the line of credit will be secured by a security interest in a second bank account. In addition, the appropriate fees and charges will also be assessed against the line of credit.

As previously explained with other preferred embodiments of the present invention, on the next payday, the payroll will be processed by the payroll processing entity (step 660) and the loan payment will be transferred to the lender to satisfy the appropriate amount of the loan (step 670). Depending on the agreed-upon terms, the entire loan balance may be paid back at one time or spread out over multiple pay periods. For purposes of method 600, this repayment of the loan acts as a credit against the special purpose checking account previously established for the borrower and brings that account back into balance, rendering the borrower eligible for another short-term payroll loan and the balance is then transferred to the borrower's regular checking or savings account (step 690).

In addition to the steps described above, in at least one preferred embodiment of the present invention, an optional step 680 may be added. In this embodiment, an additional pre-determined amount (either a fixed amount or a percentage of the loan amount) may also be withheld from the proceeds paid to the borrower as a “savings program.” The intent of this additional step is to gradually, over time, build up a cash reserve for the borrower that may enable the borrower to eventually dispense with the need for payroll advance loans altogether.

As with the previous preferred embodiments of the present invention, the limits and availability of loan proceeds, along with repayment provisions and schedules, will be determined by a number of factors including risk, past history of loan repayment, length and projected stability of employment, etc.

Those skilled in the art will recognize that the various transactions that take place in the methods described in FIG. 5 and FIG. 6 can all be tracked and reported using the various components of computer-based payday advance loan system 100 of FIG. 1. This includes, for example, the transmission of various data elements and reports where the data elements and reports can be displayed (or output) using at least one of printer 110, facsimile machine 140, or a computer display associated with computers 170 and 180 or PDA 190. In this fashion, the electronic information manipulated by computer-based payday advance loan system 100 of FIG. 1 can be transformed into multiple physical forms, suitable for review by one or more human operators that are interacting with computer-based payday advance loan system 100 of FIG. 1.

In certain preferred embodiments of the present invention, the loan amount may be determined on the basis of hours worked in the last pay period but not yet paid, since most paychecks are issued in arrears. However, in a least one preferred embodiment of the present invention, the amount of the payday loan may be based on the prospective hours to be worked by the employee. This is especially true where the employee has a long and steady work history with the current employer and the likelihood of continued employment at similar hours and pay grade is relatively certain.

During the process of underwriting the loan, the exact amount to be lent to the borrower, as well as the interest rate to be charged to the borrower, may be determined by a number of factors. For example, the status of employment (e.g., new hire vs. long-time employee), categorization of employment (e.g., part-time vs. full-time), average of paychecks over a pre-determined period of time, work place attendance average, next pay date, stability of salary (e.g, regular hourly pay vs. commission), and total number of hours logged during the current pay period when the loan is requested.

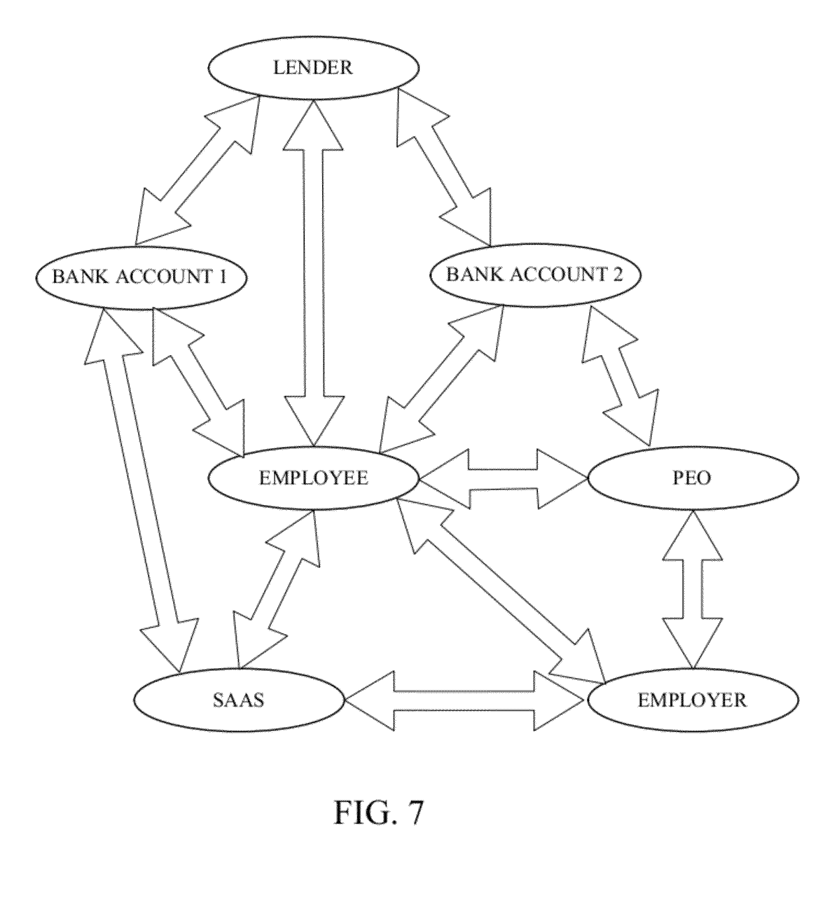

Referring now to FIG. 7, a relationship diagram for an alternative preferred embodiment of the present invention is depicted. As shown in FIG. 7, The Employee may be hired by an Employer and the Employer may contract with the PEO to perform certain HR functions (e.g., payroll, benefits, and taxes). Additionally, as previously explained, the PEO and the Employer may be the same entity in certain circumstances.

The Software as a Service (SaaS) entity is a third party service provider (e.g. loan origination and servicing company) that works with the employer or the PEO and offers the Employee the opportunity to receive short-term loans by applying over the Internet. The Employee will enter into a relationship with the SaaS entity to become eligible to participate in the short-term loan program.

Additionally, the SaaS entity will typically enter into a relationship with the Employer to receive permission from the Employer to offer the short-term loans to the Employees. The SaaS entity will work with one or more Lenders to provide funding for the short-term loans made to the Employees.

Once the Employee has been approved as being eligible for receiving a loan by the SaaS entity, the Employee makes a request via the SaaS application and, if all of the criteria that have been established for making a loan are met, the SaaS entity will approve the loan amount. The Lender will have provisioned two bank accounts for the Employee. The Lender will send the approved loan amount to the Employee's bank account (Bank Account 1) and simultaneously create a line of credit for the Employee, with the loan amount (plus any agreed upon fees and charges) acting as a draw against the line of credit. Automatically, on the Employee's next payday, an amount of money equal to the loan amount and any relevant fees will be deposited into Bank Account 2 and used to satisfy the line of credit that had been previously established for the Employee. The direct deposit will, in most cases, be facilitated by the PEO. Since the SaaS entity has a security interest in Bank Account 2, the direct deposit will be transferred from Bank Account 2 to an account owned or controlled by the SaaS entity.

In addition to lending the money to the Employee, the Lender will also create a security interest in the loan and sell the security interest to the SaaS entity. The fee paid to the Lender will include the interest on the loan and any other fees agreed to by the entities. At this point in time, the SaaS entity will own the security interest in the loan and will be entitled to receive the loan proceeds when the Employee pays off the loan.

When it's time to pay back the loan amount, and the associated fees and charges, the money will be deducted from the Employee's payroll and a direct deposit will be made to the appropriate bank accounts (e.g., Bank Account 1 and Bank Account 2). The SaaS will receive the fees and charges for handling the loan transaction and, in at least one preferred embodiment of the present invention, a revenue sharing arrangement may be established between the SaaS entity and the original lender. The revenue share may be calculated as a simple percentage or, in some cases, as a percentage based on the actual proceeds for performing loans minus any losses on any non-performing loans. In this fashion, the bank account acts like a line of credit for the Employee. As long as the Employee makes all payments on time, the Employee will be eligible for additional loans.

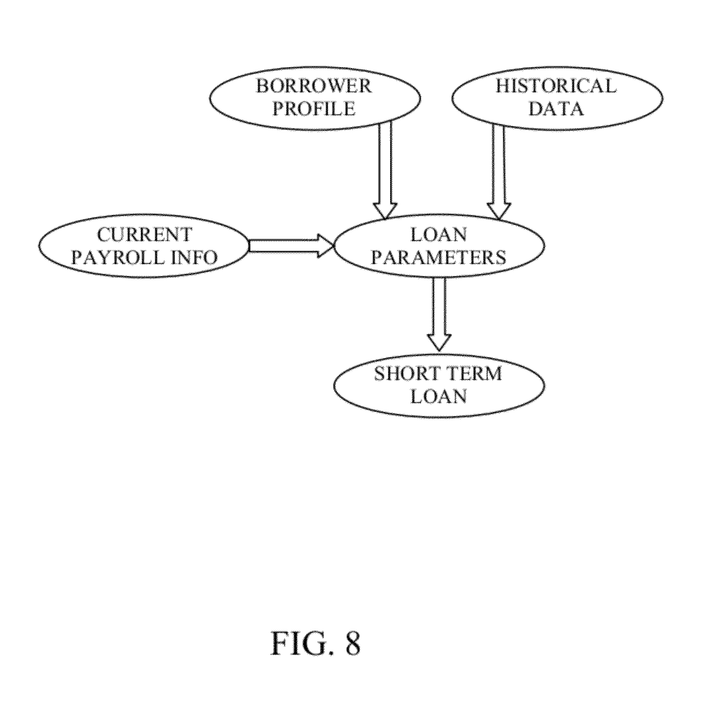

Referring now to FIG. 8, a block diagram of certain considerations to be evaluated when configuring the parameters for a payday loan advance made in accordance with a preferred embodiment of the present invention are presented. As shown in FIG. 8, when configuring the loan parameters for a given applicant, the borrower profile (credit rating, employment status, current financial obligations, etc.) and historical data for the applicant (length of time at current and past employers, repayment history, credit history, etc.) are used in determining the loan parameters to be used in constructing the short term loan to be offered to the applicant.

While some of these considerations have been previously used by lenders when making loans, the present invention goes further by adding the current payroll data for an applicant to the variables that are used to configure the actual loan. It is also important to note that the most preferred embodiments of the present invention will include a “tightly coupled” software application program interface (API) that will allow the lender to automatically extract the most recent and relevant current payroll information from the payroll system of the PEO or employer. In this fashion, the lender can use factors such as the number of hours worked in the current pay period, sick or personal time currently available, hours to be worked in the current pay period, etc. as additional factors to be evaluated when determining whether or not to advance a loan to the applicant. Similarly, the lender can more carefully tailor the size of the loan and the interest rate, using the current payroll information as part of the decision-making process. By using these additional parameters, the lender can reduce the risk associated with the loan while, in some cases, offering the applicant a larger loan, based on the current payroll data.

As discussed herein, the present invention embraces one or more methods of coordinating a loan program, comprising, in certain preferred embodiments, the steps of: executing a contract between a lending entity and an employer (or PEO) to provide a loan program for on-demand, small loans (e.g., payday loans) that may be applied for by an employee of the employer using a web-based service and application process. The on-demand loans may be offered as a benefit through the employer to employees of the employer. In general, the loan contract will have an annual percentage rate set by the employer, and wherein the annual percentage rate includes fees, interest, and other ancillary costs, which taken in total provides an overall interest rate that is less than or equal to the annual percentage rate. Payments on the loan balance will be made by deducting loan payments directly from paychecks of the employees and transmitting the loan payments to a lending entity to reduce the representative outstanding loan balances of the employees with outstanding loans over a plurality of pay periods.

Additionally, a computer-implemented method for providing loans in accordance with an alternative preferred embodiment of the present invention may also comprise the steps of: establishing a short term loan program for employees of an employer; receiving a loan request from the employee before a regularly scheduled payday for the employee; automatically determining a loan amount available to the employee based on a computer model (including risk factors, limits based on employee hours both past and future, etc.); and providing the loan to the employee under a set of loan terms, wherein at least one loan term obligates the employee to a repayment plan for the loan over a plurality of payroll cycles.

In places where the description above refers to particular implementations of a payday loan advance system/apparatus and methods it should be readily apparent that a number of modifications may be made without departing from the spirit thereof and that these implementations may be applied to other systems and methods for payday loan advances. For example, those skilled in the art will recognize that, in certain applications, the employer and the lender may, in fact, be the same entity. Additionally, the employer and the payroll processing company may be the same entity as well. Accordingly, the terms “lender” and PEO or “payroll processing company” and “borrower” and “employer” should not be deemed limiting in that regard. The accompanying claims are intended to cover such modifications as would reasonably fall within the spirit and scope of the disclosure set forth in this document. The presently disclosed preferred embodiments are, therefore, to be considered in all respects as illustrative and not restrictive, the scope of the disclosure being indicated by the appended claims rather than the foregoing description. All changes that come within the reasonable meaning of and range of equivalency for the claims set forth herein are intended to be embraced thereby.

1. An apparatus comprising:
a processor;
a memory coupled to the processor; and
a loan mechanism residing in the memory, the loan mechanism programmatically:
a) generating an approval for a loan submitted by an applicant based on a predetermined set of loan criteria;
d) recording a loan amount deposited by a lender in a first bank account;
e) recording a security interest in a second bank account in favor of the lender, the security interest being equal to the loan amount plus a predetermined fee;
f) recording a transfer of an ownership interest in the security interest from the lender to a loan processing company;
g) tracking a direct payroll deposit made on behalf the applicant, with at least a portion of the direct payroll deposit being deposited into the first bank account and the loan amount plus the predetermined fee being deposited into the second bank account;
h) transferring the loan amount plus the predetermined fee from the second bank account to the loan processing company; and
i) recording a release of the security interest in the second bank account.

2. The apparatus of claim 1 wherein the step of generating an approval for a loan submitted by an applicant based on a predetermined set of loan criteria comprises the step of evaluating a current payroll record for the applicant, the payroll record indicating at least a number of hours worked by the applicant in a current pay period.

3. The apparatus of claim 1 further comprising a network coupled to the memory, the network being connected to a computer system, the network comprising at least one wireless communication device.

4. The apparatus of claim 1 further comprising a security mechanism residing in the memory, the security mechanism providing encryption capabilities for a plurality of data.

5. The apparatus of claim 1 further comprising an eligibility mechanism residing in the memory, the eligibility mechanism programmatically evaluating the applicant's suitability for a loan based on the predetermined set of loan criteria, the predetermined set of loan criteria comprising at least one of: a credit score for the applicant; an employment absentee record for the applicant; a number of sick days allocated for the applicant; a number of vacation days allocated for the applicant; a work history for the applicant, the work history indicating employee longevity, reliability, and stability in a job; a salary level for the applicant; and a payroll payment schedule for the applicant.

6. The apparatus of claim 1 further comprising:
an eligibility mechanism residing in the memory, the eligibility mechanism programmatically evaluating the applicant's suitability for a loan based on the predetermined set of loan criteria, the predetermined set of loan criteria comprising at least one of: a credit score for the applicant; an employment absentee record for the applicant; a number of sick days allocated for the applicant; a number of vacation days allocated for an applicant; a work history for the applicant, the work history indicating employee longevity, reliability, and stability in a job; a salary level for the applicant; and a payroll payment schedule for the applicant; and
an eligibility mechanism residing in the memory, the eligibility mechanism programmatically determining an interest rate for a loan based on the predetermined set of loan criteria, the predetermined set of loan criteria comprising at least one of: a credit score for the applicant; an employment absentee record for the applicant; a number of sick days allocated for the applicant; a number of vacation days allocated for the applicant; a work history for the applicant, the work history indicating employee longevity, reliability, and stability in a job; a salary level for the applicant;
and a payroll payment schedule for the applicant.

7. The apparatus of claim 1 further comprising an assessment mechanism residing in the memory, the assessment mechanism comprising at least one user customizable web-based template to gather a plurality of information used to evaluate at least one prospective borrower and generate a risk profile for the at least one borrower.

8. The apparatus of claim 1 further comprising an eligibility mechanism residing in the memory, the eligibility mechanism programmatically determining an interest rate for a loan based on the predetermined set of loan criteria, the predetermined set of loan criteria comprising at least one of: a credit score for the applicant; an employment absentee record for the applicant; a number of sick days allocated for the applicant; a number of vacation days allocated for an applicant; a work history for the applicant, the work history indicating employee longevity, reliability, and stability in a job; a salary level for the applicant; and a payroll payment schedule for the applicant.

9. The apparatus of claim 1 further comprising:
a network coupled to the memory, the network being connected to a computer system, the network comprising at least one wireless communication device;
a security mechanism residing in the memory, the security mechanism providing encryption capabilities for a plurality of loan-related data;
an eligibility mechanism residing in the memory, the eligibility mechanism programmatically evaluating the applicant's suitability for a loan based on the predetermined set of loan criteria, the predetermined set of loan criteria comprising: a credit score for the applicant; an employment absentee record for the applicant; a number of sick days allocated for the applicant; a number of vacation days allocated for an applicant; a work history for the applicant, the work history indicating employee longevity, reliability, and stability in a job; a salary level for the applicant;
and a payroll payment schedule for the applicant;
an assessment mechanism residing in the memory, the assessment mechanism comprising at least one user customizable web-based template to gather a plurality of information used to evaluate at least one prospective borrower and generate a risk profiles for the at least one borrower;
a forms mechanism residing in the memory, the forms mechanism programmatically formatting and creating a plurality of forms to complete a loan application process for the applicant; and
wherein the step of approving a loan for the applicant based on a predetermined set of loan criteria comprises the process of evaluating a current payroll record for the applicant, the payroll record indicating at least a number of hours worked by the applicant in a current pay period.

10. A computer-implemented method for making a short-term loan comprising the steps of:
a) approving a loan for an applicant based on a predetermined set of loan criteria, said loan criteria being processed by a computer system;
b) establishing a first bank account for the applicant;
c) establishing a second bank account for the applicant;
d) depositing a loan amount from a lender in the first bank account;
e) establishing a security interest in the second bank account in favor of the lender, the security interest being equal to the loan amount plus a predetermined fee;
f) transferring an ownership interest in the security interest from the lender to a loan processing company;
g) processing a direct payroll deposit for the applicant, with at least a portion of the direct payroll deposit being deposited into the first bank account and the loan amount plus the predetermined fee being deposited into the second bank account;
h) releasing the security interest in the second bank account.

11. The method of claim 10 wherein the step of approving a loan for the applicant based on a predetermined set of loan criteria comprises the step of evaluating a current payroll record for the applicant, the payroll record indicating at least a number of hours worked by the applicant in a current pay period.

12. The method of claim 10 further comprising the step of using a security mechanism to provide for the encryption of a plurality of loan-related data.

13. The method of claim 10 further comprising the step of transmitting data related to the applicant or the first bank account or the second bank account via a network, the network comprising at least one wireless communication device.

14. The method of claim 10 further comprising the step of programmatically evaluating the applicant's suitability for a loan based on the predetermined set of loan criteria, the predetermined set of loan criteria comprising at least one of: a credit score for the applicant; an employment absentee record for the applicant; a number of sick days allocated for the applicant; a number of vacation days allocated for the applicant; a work history for the applicant, the work history indicating employee longevity, reliability, and stability in a job; a salary level for the applicant; and a payroll payment schedule for the applicant.

15. The method of claim 10 further comprising the step using at least one user customizable web-based template to gather a plurality of information used to evaluate at least one prospective borrower and generate a risk profile for the at least one borrower.

16. The method of claim 10 wherein the step of approving a loan for the applicant based on a predetermined set of loan criteria comprises the step of evaluating a current payroll record for the applicant, the payroll record indicating at least a number of hours worked by the applicant in a current pay period, and further comprising the steps of:
using a security mechanism to provide for the encryption of a plurality of loan-related data;
transmitting data related to the applicant or the first bank account or the second bank account via a network, the network comprising at least one wireless communication device;
using at least one user customizable web-based template to gather a plurality of information used to evaluate at least one prospective borrower and generate a risk profile for the at least one borrower; and
programmatically evaluating the applicant's suitability for a loan based on the predetermined set of loan criteria, the predetermined set of loan criteria comprising at least one of: a credit score for the applicant; an employment absentee record for the applicant; a number of sick days allocated for the applicant; a number of vacation days allocated for the applicant; a work history for the applicant, the work history indicating employee longevity, reliability, and stability in a job; a salary level for the applicant; and a payroll payment schedule for the applicant.

17. A program product comprising:
a loan mechanism, the loan mechanism programmatically:
a) generating an approval for a loan submitted by an applicant based on a predetermined set of loan criteria;
d) recording a loan amount deposited by a lender into a first bank account in a computer memory;
e) recording a security interest in a second bank account in favor of the lender in the computer memory, the security interest being equal to the loan amount plus a predetermined fee;
f) recording a transfer of an ownership interest in the security interest from the lender to a loan processing company;
g) tracking a direct payroll deposit made on behalf the applicant, with at least a portion of the direct payroll deposit being deposited into the first bank account and the loan amount plus the predetermined fee being deposited into the second bank account;
h) transferring the loan amount plus the predetermined fee from the second bank account to the loan processing company; and
signal bearing media bearing the loan mechanism, the signal bearing media being physically and communicatively coupled to a computer network, the computer network comprising wireless and wired communication devices, the computer network transmitting at least a portion of the loan mechanism via the signal bearing media.

18. The program product of claim 17 wherein the loan mechanism programmatically indicates approval of a loan for the applicant based on a predetermined set of loan criteria comprising a current payroll record for the applicant, the payroll record indicating at least a number of hours worked by the applicant in a current pay period.

19. The program product of claim 17 further comprising:
a security mechanism, the security mechanism providing encryption capabilities for a plurality of loan-related data;
an eligibility mechanism, the eligibility mechanism indicating approval for a loan for the applicant based on a predetermined set of loan criteria, the predetermined set of loan criteria comprising at least one of: a current payroll record for the applicant, the payroll record indicating at least a number of hours worked by the applicant in a current pay period; a credit score for the applicant; an employment absentee record for the applicant; a number of sick days allocated for the applicant; a number of vacation days allocated for an applicant; a work history for the applicant, the work history indicating employee longevity, reliability, and stability in a job; a salary level for the applicant; and a payroll payment schedule for the applicant;
a security mechanism, the security mechanism providing encryption capabilities for a plurality of loan-related data;
an assessment mechanism, the assessment mechanism comprising at least one user customizable web-based template to gather a plurality of information used to evaluate at least one prospective borrower and generate a risk profiles for the at least one borrower; and
a forms mechanism, the forms mechanism programmatically formatting and creating a plurality of forms to complete a loan application process for the applicant.

20. The program product of claim 17 wherein the signal bearing media comprises at least one of a transmission media and a recordable media.

21. A method of coordinating a loan program, the method comprising the steps of:
executing a loan contract between a lending entity and an employer to provide a loan program for at least one on-demand loan that may be applied for by an employee of the employer using a web-based service and application process with the at least one on-demand loan being offer-able as a benefit through the employer to the employees of the employer, the loan contract having an annual percentage rate;
recording a loan amount deposited by the lending entity into a first bank account;
recording a security interest in a second bank account in favor of the lending entity in the, the security interest being equal to the loan amount plus a predetermined fee;
recording a transfer of an ownership interest in the security interest from the lending entity to a loan processing company;
tracking a direct payroll deposit made on behalf the applicant, with at least a portion of the direct payroll deposit being deposited into the first bank account and the loan amount plus the predetermined fee being deposited into the second bank account;
transferring the loan amount plus the predetermined fee from the second bank account to the loan processing company; and
releasing the security interest in the second bank account.
